(19) United States
(12) Patent Application Publication
(10) Pub. No.: US 2025/0276616 A1
(43) Pub. Date: Sep. 4, 2025

(54) ISOLATOR FOR VEHICLE SEAT

(71) Applicant: Seats Incorporated, Reedsburg, WI (US)

(72) Inventor: Daniel J. Ziemer, Reedsburg, WI (US)

(21) Appl. No.: 19/066,936

(22) Filed: Feb. 28, 2025

Related U.S. Application Data
(60) Provisional application No. 63/559,710, filed on Feb. 29, 2024.

(51) Int. Cl. B60N 2/08; B60N 2/07

(52) U.S. Cl. CPC B60N 2/08; B60N 2/0727

(57) ABSTRACT

An isolator to movably support a seat of a vehicle includes an isolator frame supporting a seat portion of the seat and a Z-shaped pivot link. The Z-shaped pivot link includes a first leg portion extending in a first direction to define a first axis, a second leg portion extending in a second direction to define a second axis, and a stem portion extending between the first leg portion and the second leg portion. The stem portion extends transverse to the first and second axes to define an offset between the first axis and the second axis. The Z-shaped pivot link pivotally engages the isolator frame along the first axis defined by the first leg portion of the pivot link, to pivotally support the isolator frame relative to the vehicle.

### CROSS-REFERENCE TO RELATED APPLICATIONS

This application claims the benefit of U.S. Provisional Application No. 63/559,710, filed Feb. 29, 2024, which is hereby incorporated by reference in its entirety.

### BACKGROUND

Vehicle seats may include suspensions that allow the seats to move relative to a support frame or relative to a cab in which the seats are installed. However, typical vehicle seats may be secured directly to the suspension, which may decrease operator or passenger comfort. Thus, in some installations, it may be useful to provide an isolator system for the suspensions. For example, the isolator system may increase operator or passenger comfort (e.g., by slowing the movement of the seats, as guided by the suspensions, in response to ground contours, changes in loading on the seats, etc.).

### SUMMARY

According to one aspect of the present disclosure, an isolator can movably support a seat of a vehicle. The isolator can include an isolator frame supporting a seat portion of the seat, and a Z-shaped pivot link. The Z-shaped pivot link can include a first leg portion extending in a first direction to define a first axis, a second leg portion extending in a second direction to define a second axis, and a stem portion extending between the first leg portion and the second leg portion. The stem portion can extend transverse to the first and second axes to define an offset between the first axis and the second axis. The Z-shaped pivot link can pivotally engage the isolator frame along the first axis defined by the first leg portion of the pivot link, to pivotally support the isolator frame relative to the vehicle.

In some examples, the Z-shaped pivot link can include a plastic overmolded portion encapsulating a metallic portion of the pivot link along the first leg portion to support the metallic portion relative to the isolator frame.

In some examples, the isolator frame can define a protrusion extending towards the pivot link, the protrusion contacting the overmolded portion of the pivot link to limit lateral movement of the seat.

In some examples, the isolator can further include a locking mechanism. The locking mechanism can include a locking handle pivotably supported relative to the vehicle, and a leaf spring engaged with the locking handle. The leaf spring can be movable between a locked and unlocked position via movement of the locking handle. The locking handle can lock the isolator frame against movement relative to the vehicle when the leaf spring is in the locked position, and can permit movement of the isolator frame relative to the vehicle when the leaf spring is in the unlocked position.

In some examples, the isolator can further include a tie bar secured to the isolator frame. The tie bar can extend from the isolator frame to define a first movement limit for the isolator frame in a first direction and define a second movement limit for the isolator frame in a second direction.

In some examples, the vehicle can include a suspension supporting the seat. The suspension can include a suspension frame, and the Z-shaped pivot link can support the isolator frame relative to the suspension frame.

In some examples, the Z-shaped pivot link can support the isolator frame along the first axis defined by the first leg portion of the pivot link and can support the suspension frame along a second axis defined by the second leg portion of the pivot link.

According to another aspect of the present disclosure, a suspension for a vehicle seat can include a suspension frame, an isolator including an isolator frame, and an overmolded-wire pivot link that supports the isolator frame relative to the suspension frame. The overmolded-wire pivot link can be rotatably engaged with the suspension frame along a first axis and rotatably engaged with the isolator frame along a second axis, the first axis and the second axis being offset from each other.

In some examples, the suspension can further include a locking mechanism. The locking mechanism can include a locking handle pivotably supported relative to the suspension frame, and a leaf spring engaged with the locking handle. The leaf spring can be movable between a locked and unlocked position via movement of the locking handle. The locking handle can lock the isolator frame against movement relative to the suspension frame when the leaf spring is in the locked position, and can permit movement of the isolator frame relative to the suspension frame when the leaf spring is in the unlocked position.

In some examples, the suspension can further include a tie bar secured to the isolator frame and extending across the suspension frame. The tie bar can contact the suspension frame at a first point to define a first movement limit for the isolator frame in a first direction and can contact the suspension frame at a second point to define a second movement limit for the isolator frame in a second direction.

In some examples, one or more of the isolator frame or the suspension frame can define a protrusion extending towards the overmolded-wire pivot link. The protrusion can contact the overmolded-wire pivot link to limit lateral deflection of the suspension.

In some examples, the overmolded-wire pivot link can include a plastic overmolded portion encapsulating a metallic wire portion of the pivot link.

In some examples, a first end of the wire portion can extend along the first axis and can be encapsulated by the plastic overmolded portion along the first axis, and a second end of the wire portion can extend along the second axis and can be encapsulated by the plastic overmolded portion along the second axis.

In some examples, the overmolded portion of the pivot link can encapsulate the first end and the second end of the pivot link to provide a first cylindrical bearing surface and a second cylindrical bearing surface, respectively, to rotatably engage the suspension frame and the isolator frame. The first and second cylindrical bearing surfaces can define the first and second axes, respectively.

In some examples, one or more of the first or second ends of the wire portion can deviate from parallel with the first or second axis.

According to yet another aspect of the present disclosure, a method of assembling an isolator system for a vehicle seat can include providing a Z-shaped link having an internal wire portion and an overmolded plastic exterior portion, engaging a first leg of the Z-shaped link with an isolator frame along a first axis defined by the first leg, so that the first leg is rotatable about the first axis relative to the isolator frame, and engaging a second leg of the Z-shaped link with a portion of a vehicle along a second axis defined by the second leg, so that the second leg is rotatable about the second axis relative to the vehicle. Engaging the first and second legs of the Z-shaped link with the isolator frame and the vehicle can offset rotational engagement of the isolator frame by the Z-shaped link from rotational engagement of the vehicle by the Z-shaped link, via a stem of the Z-shaped link, the stem extending between the first leg and the second leg of the Z-shaped link, transverse to the first and second axes.

In some examples, engaging the second leg of the Z-shaped link with the portion of the vehicle can include engaging the second leg of the Z-shaped link with a suspension frame of the vehicle seat along the second axis defined by the second leg, so that the second leg is rotatable about the second axis relative to the suspension frame.

In some examples, the method can further include limiting lateral deflection of the isolator frame relative to the suspension frame via contact between the overmolded portion of the Z-shaped link and a protrusion that extends away from one or more of the isolator frame or the suspension frame and towards the Z-shaped link.

In some examples, the method can further include rotatably securing the first leg of the Z-shaped link to the isolator frame via a first rivet, and rotatably securing the second leg of the Z-shaped link to the vehicle via a second rivet.

In some examples, the method can further include restricting movement of the isolator frame in a first direction via contact between a tie bar arranged between opposing sides of the isolator frame and an edge of a cutout defined by the vehicle, the tie bar extending through the cutout defined by the vehicle.

### BRIEF DESCRIPTION OF THE DRAWINGS

The accompanying drawings, which are incorporated in and form a part of this specification, illustrate aspects of the invention and, together with the description, serve to explain the principles of aspects of the invention:

FIG. 1 is an axonometric view of a suspension for a vehicle seat, including an isolator system according to an aspect of the invention.

FIG. 2A is an axonometric partial view of the suspension of FIG. 1 including a pivot link.

FIG. 2B is a cross-sectional partial view of the suspension of FIG. 1 and the pivot link of FIG. 2A.

FIG. 2C is an axonometric partial view of the suspension of FIG. 1 showing an example connection between the pivot link of FIG. 2A and the suspension.

FIG. 2D is an axonometric partial view of the suspension of FIG. 1 showing another example connection between the pivot link of FIG. 2A and the suspension.

FIG. 3 is a side view of the pivot link of FIG. 2A.

FIG. 4A is an axonometric partial view of the suspension of FIG. 1 with a lockout system in a first position, with a isolator frame rendered transparently.

FIG. 4B is an axonometric partial view of the suspension of FIG. 1 with the lockout system of FIG. 4A in a second position, with the isolator frame rendered transparently.

FIGS. 5A and 5B are axonometric partial views of the suspension of FIG. 1, including a tie bar.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other implementations and of being practiced or of being carried out in various ways.

The following discussion is presented to enable a person skilled in the art to make and use aspects of the invention. Various modifications to the illustrated implementations will be readily apparent to those skilled in the art, and the generic principles herein can be applied to other implementations and applications without departing from the scope of the disclosed technology. Thus, aspects of the invention are not intended to be limited to the implementations shown, but are to be accorded the widest scope consistent with the principles and features disclosed herein.

The following detailed description is to be read with reference to the figures, in which like elements in different figures have like reference numerals. The figures, which are not necessarily to scale, depict selected implementations and are not intended to limit the scope of aspects of the invention. Skilled artisans will recognize the examples provided herein have many useful alternatives and fall within the scope of aspects of the invention.

As noted above, some vehicle seats can include suspensions that permit seating portions and other components of the seats to move relative to a reference structure. For example, some seat suspensions can permit a seat portion of a vehicle seat to move upward or downward relative to a vehicle cab in which the seat is installed. This arrangement, for example, may improve comfort during travel over rough surfaces or may otherwise comfortably accommodate passengers of different sizes.

In some seat designs, it may be useful to include an isolator. Generally, an isolator can permit the seat portion of the vehicle seat to move separately from a frame of the suspension or other support structures of a vehicle (e.g., along different degrees of freedom than a corresponding suspension). For example, isolators can permit the seat portion of the vehicle seat to rock or slide forward and backward relative to a suspension frame that supports the seat portion for upward and downward movement. Thus, for example, acceleration and deceleration of the vehicle can be absorbed by the movement of the isolator as well as movement of the suspension frame, with corresponding improvements in ride quality for passengers.

In conventional approaches, isolators for suspensions can tend to be relatively complex to manufacture, install, and maintain. For example, conventional isolators can include a large number of specialized components, including multiple fasteners and corresponding bushings or other guide components. Further, the relatively tight tolerancing of typical suspension components can make manufacturing particularly difficult or costly.

Examples of the disclosed technology can address these and other issues. For example, the isolator as disclosed herein can include one or more Z-shaped links, which may provide improved support and movement to an isolator frame relative to the suspension frame. In some examples, the links can be installed to rotatably engage the isolator frame at a first leg (e.g., forming a first set of axes) and to rotatably engage the suspension frame at a second leg (e.g., forming a second set of axes). In some examples, a stem portion of the Z-shaped links may connect the first leg and the second leg and define an offset therebetween (e.g., extending perpendicularly or otherwise transversely to the first and second legs). Correspondingly, the isolator frame can be reliably and securely supported for pivoting (or other) movement relative to the suspension frame as part of an operationally robust system that is relatively easy to manufacture and install.

In some examples, the Z-shaped link can include a metal (e.g., wire) core and an overmolded plastic covering. In some examples, the overmolded plastic portion can provide a dependably manufacturable bearing surface for operation of the isolator. Further, a wire core can provide strength and rigidity to the links, with the overmolded portion encasing the wire core to effectively mitigate any deviation of the wire core from a desired orientation (e.g., an angular deviation between the first and second legs, out of parallel alignment). In some examples, other features can also (or alternatively) be provided, including improved locking mechanisms, structural features for improved support and operation, or improved stop features to define particular ranges of motion for the isolator frame.

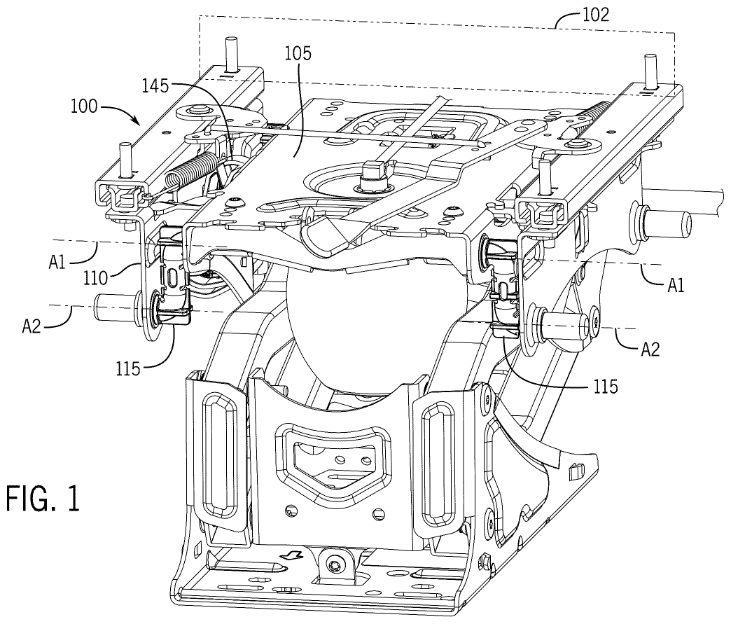

FIG. 1 illustrates an example of a suspension 100 of a vehicle seat. In some examples, the suspension 100 may support a seat portion 102 of the vehicle seat and may include one or more movable suspension components, which may support the seat portion of the vehicle seat. For example, the suspension 100 can be configured as a scissor-style or other style of known suspension systems. In this regard, any variety of suspension sub-assemblies can be included to support a seat in cooperation with isolator systems as disclosed herein. Further, although use with suspension systems may be particularly useful, some isolator system can be employed to support vehicle seats in other configurations. For example, rather an isolator frame being secured to a moveable suspension frame (e.g., via one or more Z-shaped links, as shown in FIG. 1), the isolator frame may instead be secured to a base (e.g., fixed) structure of the vehicle seat, or to another fixed feature within a vehicle cab (e.g., in either case, also via the Z-shaped link(s)).

In some examples, the suspension 100 may include a suspension frame 105 and isolator frame 110, which may be moveably secured together via one or more pivot links. In some examples, the suspension frame 105 may be moveable relative to the vehicle cab to permit the seat portion 102 to move between raised and lowered positions (e.g., up and down) in response to uneven terrain or other factors. Correspondingly, the isolator frame 110 can support the seat portion 102 relative to the suspension frame 105 to permit the seat portion to also move between forward and rearward positions (e.g., substantially perpendicular to the movement direction of the suspension frame 105). Put differently, the isolator frame may permit movement of the seat portion 102 along one or more degrees of freedom that are different from the degree(s) of freedom provided by the suspension frame.

In one particular example, the suspension frame 105 and the isolator frame 110 may be secured together via one or more Z-shaped pivot links 115. The Z-shaped pivot links 115 may support the isolator frame 110 relative to the suspension frame 105 along offset axes. Thus, the pivot links 115 may permit corresponding movement of the isolator frame 110 relative to the suspension frame 105, with pivoting support of the two frames 105, 110 along the offset axes. For example, the pivot links 115 may thus permit forward and backward or “swinging” movement as guided by a parallel linkage formed by the links 115 and the frames 105, 110.

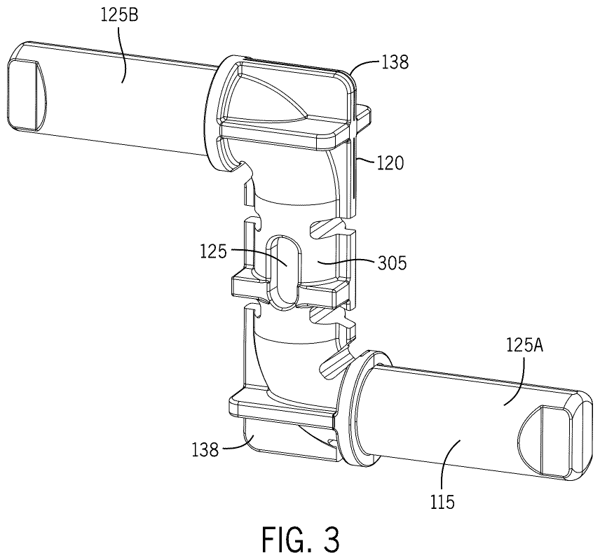

In some examples, with regard to FIG. 3, the pivot links 115 may include a first leg 125A and a second leg 125B, which may be connected together via a stem portion 305. In some examples, the stem portion 305 may define an offset between the first and second leg portions 125A, 125B, which may correspond to an offset of the respective axes of the suspension frame 105 and the isolator frame 110. In particular, the stem portion 305 may generally extend transverse to the legs 125A, 125B, and the corresponding axes, to provide the offset. Further, in some examples, the arrangement of the first leg 125A, the second leg 125B, and the stem portion 305 may form a substantially Z-shaped body of the pivot link 115, with the first and second legs 125A, 125B extending substantially parallel to each other, but in opposing directions. In some examples, the stem portion 305 may extend substantially perpendicular to the leg portions 125A, 125B, between the leg portions 125A, 125B.

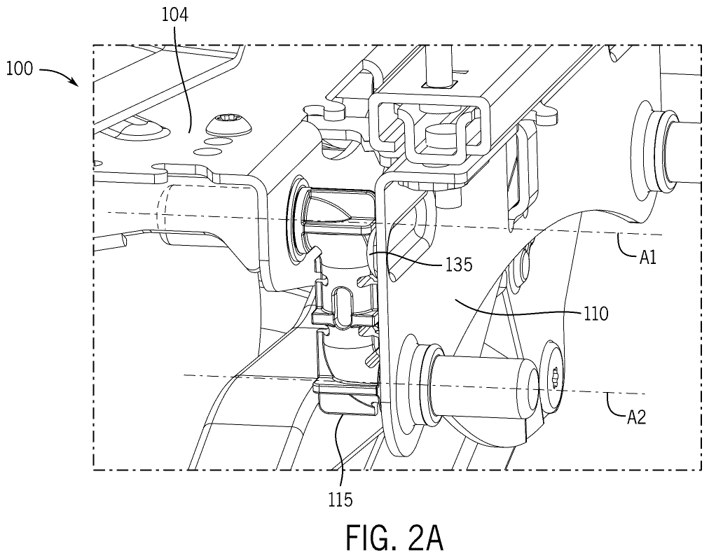

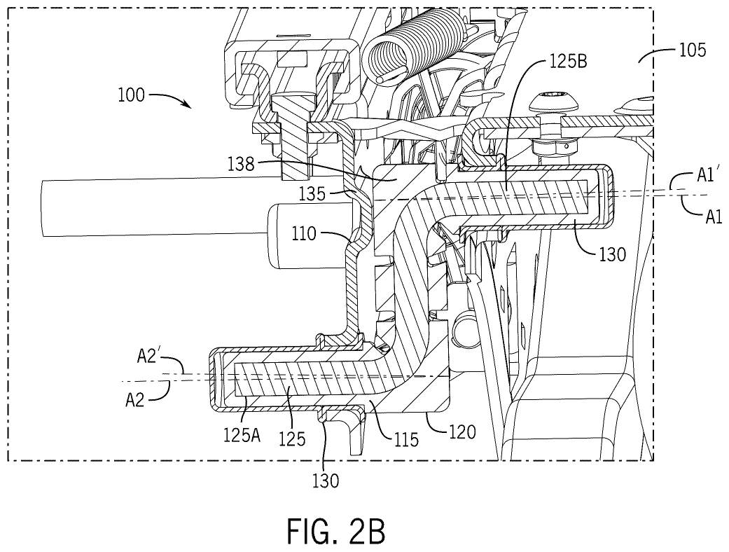

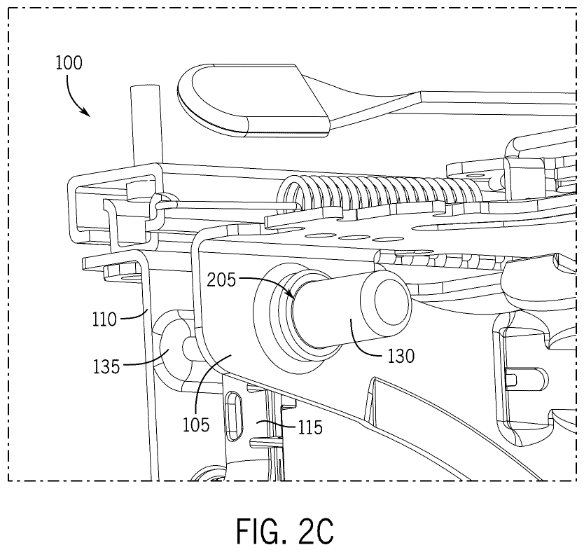

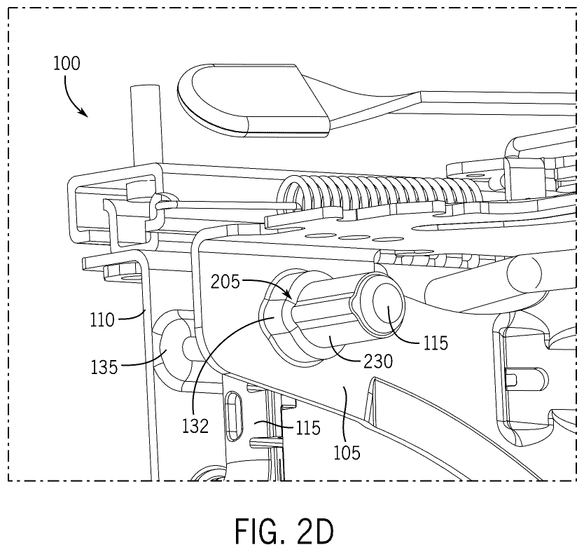

As shown in FIG. 2A, each of the Z-shaped links 115 may define a first axis A1 (e.g., extending along the first leg 125A) for rotatable engagement between the suspension frame 105 and the link 115 and a second axis A2 (e.g., extending along the second leg 125B) for rotatable engagement between the isolator frame 110 and the link 115. Put differently, the links 115 of the suspension 100 can rotatably engage and support the isolator frame 110 relative to the suspension frame 105, with the Z-shaped links 115 rotatably engaging the suspension frame 105 for rotation about the first set of axes A1 and rotatably engaging the isolator frame 110 for rotation about the second set of axes A2.

In some examples, as mentioned above, the first and second axes A1, A2 may be offset from each other. In some examples, the offset between the first and second axes A1, A2 may correspond to a length of the stem portion 305 of the link 115 (e.g., a distance between the first leg 125A and the second leg 125B of the link 115).

In one particular example, the suspension 100 may include four (4) links 115, which may secure the suspension frame 105 to the isolator frame 110 at corners or other end portions of the suspension frame 105 and the isolator frame 110. Thus, for example, the axes A1 formed by the first legs 125A of the links can be aligned along a common first plane and the axes A2 formed by the second legs 125B can be aligned along a common second plane that is vertically offset from the first plane (e.g., a distance about equal to a length of the stem portion 305 of the links 115). As a result, the links 115 can collectively with the frames 105, 110 provide a parallel linkage to permit swinging movement of the isolator frame 110 relative to the suspension frame 105 (e.g., for movement generally transverse to a vertical direction supported by the suspension frame 105).

Turning to FIG. 2B, in some examples, the pivot link 115 can include a rigid internal component (e.g., to provide structural support to the pivot link) and a molded external component (e.g., to provide for potential tolerancing issues with respect to the rigid internal component). For example, the Z-shaped link 115 may include a wire (or other metallic) portion 125 and an overmolded portion 120 surrounding (e.g., encapsulating) the wire portion 125. In some examples, the wire portion 125 may be formed from a metal or metallic material in order to provide appropriate strength and rigidity to support the isolator frame 110 relative to the suspension frame 105. For example, the wire portion 125 may be formed from standard-gauge wire, metallic tubing, conduit, rebar, metallic rod, or any other metallic material of sufficient strength to support the isolator frame 110. In one particular example, the wire portion 125 can be formed from ⅜″ or other diameter metal rod that is bent into the desired shape (e.g., the Z-shape). Correspondingly, the overmolded portion 120 is generally formed of a plastic (e.g., a polymeric or composite) material that can be molded around the wire portion 125 (e.g., after the wire portion 125 has been formed to shape). In some examples, the overmolded portion 120 can include nylon, acetal, or various other composite materials (e.g., nylon or acetal blended with glass or Teflon™ material). (Teflon is a trademark of The Chemours Company FC, LLC.).

In some examples, the overmolded portion 120 of the links 115 may form one or more flanges 138 or other protrusions, e.g., arranged at external corners of the Z-shaped links 115. In some examples, the flanges 138 (or one of the flanges 138) may be configured to contact a protrusion 135 extending from the isolator frame 110 towards the link 115. For example, during lateral loading of the suspension 100, the flange 138 may contact the protrusion 135 and thereby reduce the degree of permitted lateral deflection due to the loading. In the illustrated example, the protrusions are included on the isolator frame 110 as integrally formed protrusions that extend inboard towards the suspension frame 105. In other example, other configurations are possible, including with protrusions that extend in other directions or from other components (e.g., the suspension frame 105) or that are formed in other ways.

In some examples, the links 115 may be include the wire portion 125 and the overmolded portion 120 to account for tolerancing issues during manufacturing of the links 115. For example, when manufacturing the links 115, it may be difficult to maintain appropriate tolerances when forming the rigid metallic materials into a shape (e.g., a Z-shape) with offset axes. Thus, for example, offset axis may extend along non-parallel directions, with a corresponding angular difference. In some examples, an angular difference between the offset axes defined by the first and second legs 125A, 125B can result in undesired movement or otherwise suboptimal performance of the corresponding isolation system. For example, typical manufacturing processes may result in deviation of legs 125A, 125B of the wire portion 125 by up to 3 degrees from parallel with a relevant support axis (e.g., as shown by angled axes A1′ and A2′ of FIG. 2B). This deviation can result in mismatched rotational movement at the various links 115 in the assembled suspension 100, which may correspond to an overall uncomfortable or otherwise poor experience for passengers.

To avoid the above-noted tolerancing issues, in some examples, the links 115 may include the overmolded portion 120. For example, during manufacturing, the wire portion 125 may be bent into the desired shape (e.g., the Z-shape as shown). Following this, the wire portion 125 may be inserted into a mold (e.g., a mold forming the desired end shape of the links 115). Once the wire portion 125 is within the mold, a plastic material may be injected, cast or otherwise molded around the wire portion, with the plastic material filling the mold around the wire portion to account for various angular deviations between the legs of the links 115.

Thus, the overmolded portion 120 can generally be more easily manufactured to have tighter tolerances than a corresponding wire portion 125. In some cases, the overmolded portion 120 can be added onto the wire portion 125 to provide consistently oriented bearing surfaces along the axes A1, A2 that can reduce (e.g., eliminate) any effect on suspension movement that may result from angular deviations of the wire portion 125. For example, the overmolded portion 120 may extend around legs of the wire portion 125 to define parallel rotational axes, despite non-parallel orientation of the legs of the wire portion 125. Further, the inclusion of the wire portion 125 within the overmolded portion 120 can increase the overall structural integrity (e.g., strength) of the links 115.

In some examples, the material thickness of the overmolded portion 120 can be selected so that the wire portion 125 can be fully enclosed along a bearing surface (e.g., formed along the legs 125A, 125B) between the link 115 and the suspension 100, despite deviation of the legs 125A, 125B of the wire portion 125 by three (or more) degrees from parallel. For example, the overmolded portion 120 can fully encapsulate the wire portion 125. In other examples, the overmolded portion 120 can alternatively enclose the wire portion 125 along a circumference of the legs 125A, 125B of the wire portion 125. In some examples, the overmolded portion 120 can fully encapsulate the legs 125A, 125B of the wire portion 125 to provide a parallel arrangement between the legs of the links 115 (i.e., to define parallel, offset axes of rotation for the legs). As a result, the axes A1, A2 as defined by the overmolded portion 120 may deviate from parallel by less than about 2.0 degrees, although deviation of the legs 125A, 125B from parallel may be larger. In some configurations, the overmolded portion 120 may be at least 0.08 inches thick (e.g., as measured between the wire portion 125 and an exterior surface of the overmolded portion).

In some examples, as shown in FIG. 2C, the links 115 may be secured to the respective suspension frame 105 and isolator frame 110 via a rivet 130 (e.g., a tubular rivet). In some examples, the rivet 130 may rotatably support the links 115 relative to the isolator frame 110 and the suspension frame 105 to permit movement between the isolator frame 110 and the suspension frame 105 via the links 115. In some examples, the use of the rivet 130 can help to provide an increased contact area between the Z-shaped links 115 and the suspension/isolator frames 105, 110, without requiring the corresponding material of the suspension/isolator frames 105, 110 to be excessively thick or requiring expensive or complicated machining of the suspension/isolator frames 105, 110. In some examples, a rivet 130 can be disposed on the suspension frame 105 and protrude inboard of the suspension frame 105, while a rivet 130 disposed on the isolator frame 110 can protrude outboard of the suspension frame 105. Further, in some examples, the rivet 130 may fully encapsulate an end of the pivot links 115 (e.g., to mitigate the risk of debris, dirt, etc. entering the connection).

In some examples, the suspension/isolator frames 105, 110 can include one or more rivet openings 205, which may be configured to receive the legs 125A, 125B of the links 115 and correspondingly receive the rivet 130. The rivet openings 205 can be formed (e.g., extruded or otherwise formed) on the suspension/isolator frames 105, 110. In some examples, as the tubular rivet 130 is pressed from opposing sides within the corresponding rivet opening 205, the tubular rivet 130 can be deformed to form a circumferential collar (e.g., a crimped portion of the rivet), which retains the rivet 130 (and thus the respective legs 125A, 125B) in the opening 205.

In some examples, as shown in FIG. 2D, a rivet 230 may include a crimped structure that can be used to secure the links 115 to the suspension/isolator frames 105, 110. For example, the suspension/isolator frames 105, 110 can include one or more rivet openings 205 defining cutouts 132 that deviate from the substantially circular profile of the openings 205. In some examples, the cutouts 132 can be formed (e.g., extruded or otherwise formed) on the suspension/isolator frames 105, 110. In some examples, as the tubular rivet 230 is pressed from opposing sides within the corresponding rivet opening 205, the tubular rivet 230 can be deformed to form a circumferential collar, which retains the rivet 230 in the opening 205. In other examples, the rivet 230 may form a radial deformation (e.g., a protrusion) that may extend into the corresponding cutout 132. Thus, the cutout 132 may provide further structural support to retain the rivet 230 and thus the link 115. Further, in some examples, the rivet 230 may include an open end portion, which may permit a corresponding end of the links 115 to protrude through the open end portion of the rivet 230. Thus, the rivet 230 may accommodate links 115 with varying lengths of the legs 125A, 125B.

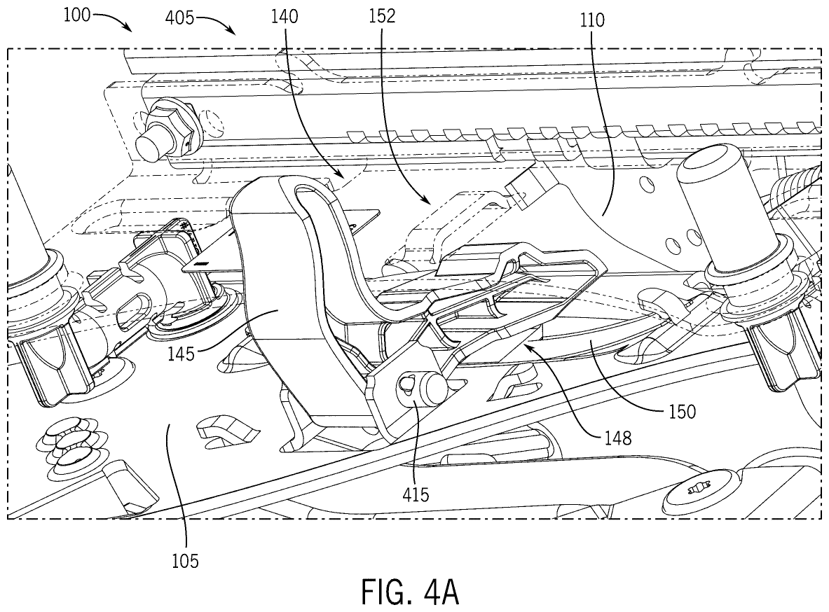

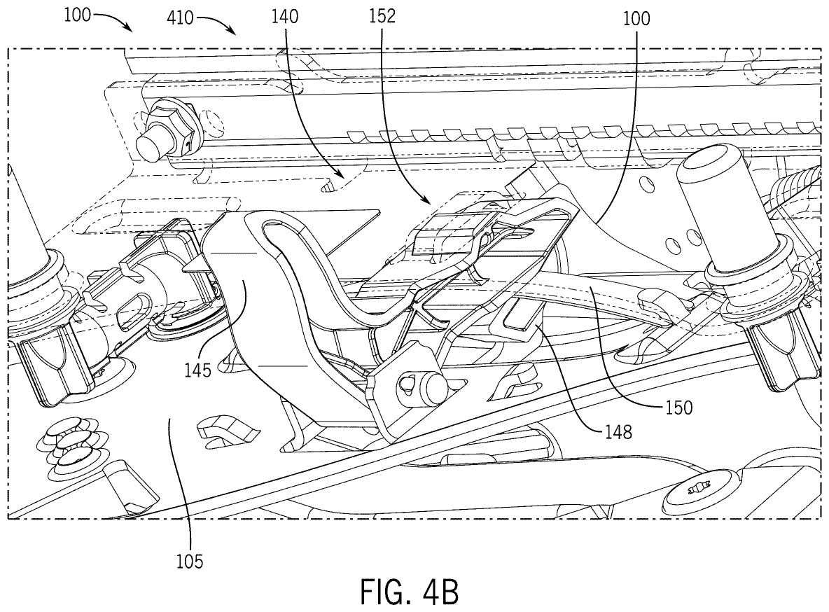

FIGS. 4A and 4B illustrate an example of a locking mechanism 140 of the suspension 100 in a first, locked position 405 (see, e.g., FIG. 4A) and a second, unlocked position 410 (see, e.g., FIG. 4B). In some examples, the locking mechanism 140 may include a handle 145 pivotally secured to the suspension frame 105 via a pivot pin 415. In some examples, movement of the handle 145 between the locked position 405 and the unlocked position 410 may correspond to movement of a leaf spring 150 (or any other known biasing element) to lock or unlock movement of the isolator frame 110 relative to the suspension frame 105.

In some examples, the leaf spring 150 may be secured to the handle 145 through a mounting aperture 148 defined by the handle 145. Thus, as shown in FIG. 4A, when the handle 145 is in the locked position 405, the leaf spring 150 may be deformed within a slot 152 defined by the isolator frame 110. Further, the leaf spring 150 may be bi-stable, so that when in the locked position 405, the leaf spring 150 may remain in the locked position until the handle 145 is actuated into the unlocked position 410. Correspondingly, as shown in FIG. 4B, when the handle 145 is in the unlocked position 410, the leaf spring 150 may be deformed to extend out of the slot 152 and may remain in the unlocked position 410 until the handle 145 is actuated into the locked position 405.

In some examples, when in the locked position 405, the leaf spring 150 may lock movement of the isolator frame 110 relative to the suspension frame 105 (e.g., via extension of the leaf spring 150 into the slot 152 of the isolator frame 110). Correspondingly, when in the unlocked position 410, the leaf spring 150 may unlock (e.g., permit) movement of the isolator frame 110 relative to the suspension frame 105 (e.g., via retraction of the leaf spring out of the slot 152). In other examples, other engagements between the handle, leaf spring, suspension frame, and isolator frame may be possible, with similar effect (e.g., with the handle 145 may be rotatably supported relative to the isolator frame 110, movable to engage with the suspension frame 105 when in the locked position, etc.).

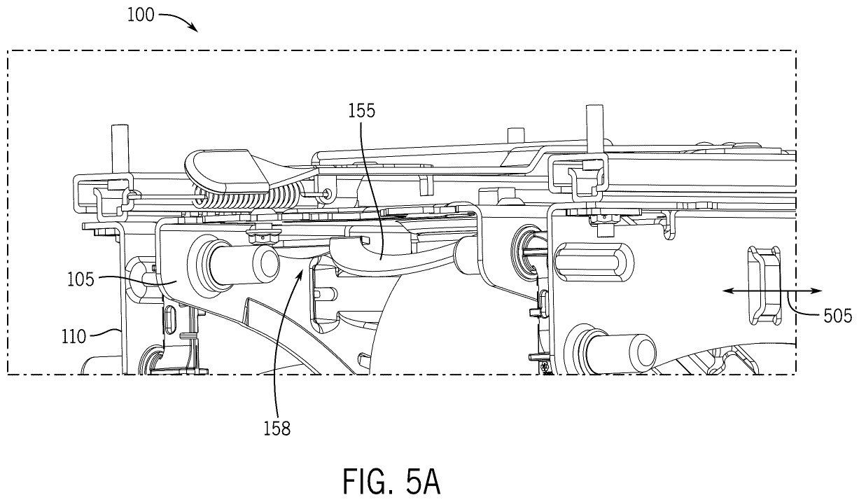

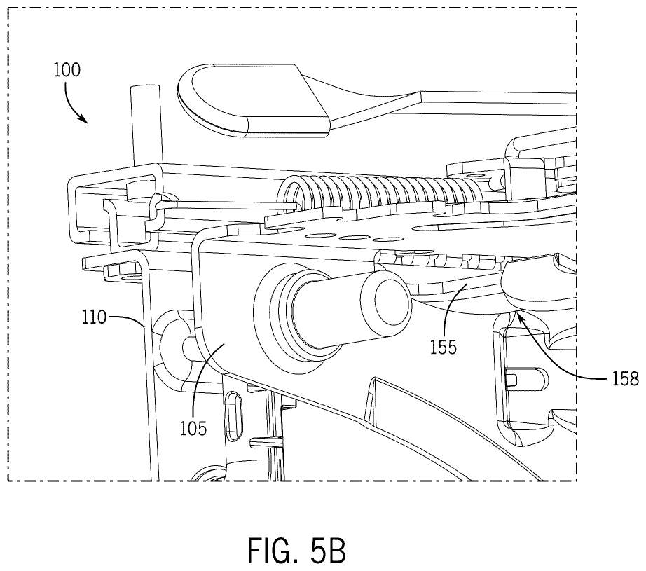

FIGS. 5A and 5B show examples of a tie bar 155 of the suspension 100. In some examples, the tie bar 155 may limit relative movement (e.g., swinging movement as shown by arrow 505) of the isolator frame 110 relative to the suspension frame 105. For example, the tie bar 155 may extend across the suspension 100 and be secured between opposing lateral sides of the isolator frame 110. Further, the tie bar 155 may extend from the isolator frame 110 through a corresponding cutout 158 of the suspension frame 105. Thus, during movement of the isolator frame 110 relative to the suspension frame 105 (e.g., via the links 115), the edges of the cutout 158 may contact the tie bar 155 (e.g., to limit movement of the isolator frame 110 relative to the suspension frame 105). Put differently, the tie bar 155 may contact respective edges of the cutout 158 to define a first movement limit of the isolator frame 110 relative to the suspension frame 105 in a first direction and define a second movement limit of the isolator frame 110 relative to the suspension frame 105 in a second, opposite direction.

In some examples, the above-described arrangement may provide various benefits, including relatively smooth overall movement, well-defined stop locations, and improved lateral stability for the isolator frame 110. However, in other examples, rather than extending across the suspension from a first side of the isolator frame to a second side of the isolator frame, the tie bar 155 may instead extend only partially across the suspension, may be connected to only one side of the isolator frame, or may be secured to the suspension frame and contact the isolator frame to define the range of movement.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

In this regard, for example, a suspension for a vehicle seat can be assembled by providing Z-shaped links that include an internal metallic portion and a plastic overmolded portion surrounding the metallic portion. In some examples, the plastic overmolded portion can be molded around a formed metal wire (e.g., with a nylon exterior overmolded onto a formed ⅜″ rod or other structure). In some examples, this approach can facilitate implementation of relatively tight tolerances for the exterior of the Z-shaped links, which is secured to components of the suspension, while not requiring a high degree of precision for the internal metallic portion. Put differently, the overmolding approach permits variation in the manufacture of the internal metallic portion, due to the precision of the overmolded portion, which may facilitate ease of manufacturing, without detriment to system performance.

In some examples, once the Z-shaped links have been formed (e.g., including a first leg portion and a second leg portion secured together via a stem portion), the first leg of the Z-shaped links can be rotatably engaged with an isolator frame along a first axis (e.g., formed by the first leg) and rotatably engaged with a suspension frame along a second axis (e.g., formed by the second leg). In some examples, based on the length of the stem portion, the first and second axes can be offset, but parallel to each other. Thus, for example, the Z-shaped links can rotatably support the isolator frame within a first plane (e.g., formed by the first axes of the links) and be rotatably supported on the suspension frame within a second, offset plane) (e.g., formed by the second axes of the links), which may permit “swinging” movement of the isolator frame relative to the suspension frame.

In some examples, to rotatably secure the links to the isolator frame and the suspension frame, one or more rivets can be installed around the first and second legs of the links. For example, the first leg of the link may be arranged through a corresponding opening of the isolator frame. Following this, a rivet may be arranged around the first leg and deformed to secure the link to the isolator frame. Correspondingly, the second leg of the link may be arranged through a corresponding opening of the suspension frame. Following this, a rivet may be arranged around the second leg and deformed to secure the link to the suspension frame. In some examples, once the links are secured to the isolator frame and the suspension frame, a flange of the link (e.g., formed by the overmolded portion) may contact a protrusion extending from the isolator frame towards the link to mitigate lateral deflection of the suspension.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, unless otherwise noted, features or functionality of any particular example presented herein can be substituted into or otherwise combined with other examples, including to supplement or replace various features or functionality of the other examples.

Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, the term “Z-shaped” indicates a shape that includes a stem portion, with at least two leg portions extending in opposing directions from spaced apart locations on the stem portion. In some examples, a “Z-shaped” member can include leg portions extending from opposite ends of the leg portion at substantially right angles to the stem portion (i.e., deviating from right angles by less than 5 degrees), or can with or without curved, chamfered, or otherwise non-square connecting regions between the leg portions and the stem portion. In some examples, a “Z-shaped” member can include leg portions that extend as part of a continuous (e.g., non-angled) curve from either end of a straight or curved stem portion. Further, some “Z-shaped” members may include a first leg that is longer than a second leg.

Also as used herein, unless otherwise specified or limited, “substantially parallel” indicates a direction that is within ±12 degrees of a reference direction (e.g., within ±6 degrees or ±3 degrees), inclusive. Similarly, unless otherwise specified or limited, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise defined or limited, ordinal numbers are used for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Unless otherwise specified or limited, the terms “about” and “approximately,” as used herein with respect to a reference value, refer to variations from the reference value of ±20% or less (e.g., ±15, +10%, +5%, etc.), inclusive of the endpoints of the range. Similarly, as used herein with respect to a reference value, the term “substantially equal” (and the like) refers to variations from the reference value of less than +5% (e.g., +2%, +1%, +0.5%) inclusive. Where specified in particular, “substantially” can indicate a variation in one numerical direction relative to a reference value. For example, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

As used herein in the context of a vehicle seat (or seat component), unless otherwise defined or limited, the term “lateral” refers to a direction that extends at least partly to a left or a right side of a front-to-back reference line defined by the seat (or seat component). Accordingly, for example, a lateral side wall of a suspension for a set of a vehicle can be a left side wall or a right side wall of the suspension, relative to a frame of reference of an operator who is sitting on the seat for normal operation of the vehicle.

As used herein, unless otherwise defined or limited, the terms “inboard” and “outboard” refer to a relative relationship (e.g., a lateral distance) between one or more objects or structures and a centerline of a reference system. For example, a first structure that is inboard of a second structure is positioned laterally offset from the second structure so that a distance between the first structure and the centerline of the system is less than a distance between the second structure and the centerline of the system. Conversely, a first structure that is outboard of a second structure is positioned laterally offset from the second structure so that a distance between the first structure and the centerline of the system is greater than a distance between the second structure and the centerline of the system.

Some figures may include multiple instances of similar structures or structural relationships. For convenience of presentation, in select figures, only some of these similar structures or relationships may be specifically labeled with a reference number. One of skill in the art will recognize that the features not labeled with reference numbers can include similar aspects and perform similar functions to similar features that are labeled with reference numbers.

1. An isolator to movably support a seat of a vehicle, the isolator comprising:
an isolator frame supporting a seat portion of the seat; and
a Z-shaped pivot link, including:
a first leg portion extending in a first direction to define a first axis;
a second leg portion extending in a second direction to define a second axis; and
a stem portion extending between the first leg portion and the second leg portion, the stem portion extending transverse to the first and second axes to define an offset between the first axis and the second axis;
the Z-shaped pivot link pivotally engaging the isolator frame along the first axis defined by the first leg portion of the pivot link, to pivotally support the isolator frame relative to the vehicle.

2. The isolator of claim 1, wherein the Z-shaped pivot link includes a plastic overmolded portion encapsulating a metallic portion of the pivot link along the first leg portion to support the metallic portion relative to the isolator frame.

3. The isolator of claim 2, wherein the isolator frame defines a protrusion extending towards the pivot link, the protrusion contacting the overmolded portion of the pivot link to limit lateral movement of the seat.

4. The isolator of claim 1, further comprising:
a locking mechanism, including:
a locking handle pivotably supported relative to the vehicle; and
a leaf spring engaged with the locking handle, the leaf spring being movable between a locked and unlocked position via movement of the locking handle;
wherein the locking handle locks the isolator frame against movement relative to the vehicle when the leaf spring is in the locked position, and permits movement of the isolator frame relative to the vehicle when the leaf spring is in the unlocked position.

5. The isolator of claim 1, further comprising:
a tie bar secured to the isolator frame, the tie bar extending from the isolator frame to define a first movement limit for the isolator frame in a first direction and define a second movement limit for the isolator frame in a second direction.

6. The isolator of claim 1, wherein the vehicle includes a suspension supporting the seat, the suspension including:
a suspension frame, the Z-shaped pivot link supporting the isolator frame relative to the suspension frame.

7. The isolator of claim 6, wherein the Z-shaped pivot link supports the isolator frame along the first axis defined by the first leg portion of the pivot link and supports the suspension frame along the second axis defined by the second leg portion of the pivot link.

8. A suspension for a vehicle seat, comprising:
a suspension frame;
an isolator including an isolator frame; and
an overmolded-wire pivot link that supports the isolator frame relative to the suspension frame, the overmolded-wire pivot link being rotatably engaged with the suspension frame along a first axis and rotatably engaged with the isolator frame along a second axis, the first axis and the second axis being offset from each other.

9. The suspension of claim 8, further comprising:
a locking mechanism, including:
a locking handle pivotably supported relative to the suspension frame; and
a leaf spring engaged with the locking handle, the leaf spring being movable between a locked and unlocked position via movement of the locking handle;
wherein the locking handle locks the isolator frame against movement relative to the suspension frame when the leaf spring is in the locked position, and permits movement of the isolator frame relative to the suspension frame when the leaf spring is in the unlocked position.

10. The suspension of claim 8, further comprising:
a tie bar secured to the isolator frame and extending across the suspension frame, the tie bar contacting the suspension frame at a first point to define a first movement limit for the isolator frame in a first direction and contacting the suspension frame at a second point to define a second movement limit for the isolator frame in a second direction.

11. The suspension of claim 8, wherein one or more of the isolator frame or the suspension frame defines a protrusion extending towards the overmolded-wire pivot link, the protrusion contacting the overmolded-wire pivot link to limit lateral deflection of the suspension.

12. The suspension of claim 8, wherein the overmolded-wire pivot link includes a plastic overmolded portion encapsulating a metallic wire portion of the pivot link.

13. The suspension of claim 12, wherein a first end of the wire portion extends along the first axis and is encapsulated by the plastic overmolded portion along the first axis, and a second end of the wire portion extends along the second axis and is encapsulated by the plastic overmolded portion along the second axis.

14. The suspension of claim 13, wherein the overmolded portion of the pivot link encapsulates the first end and the second end of the pivot link to provide a first cylindrical bearing surface and a second cylindrical bearing surface, respectively, to rotatably engage the suspension frame and the isolator frame; and
wherein the first and second cylindrical bearing surfaces define the first and second axes, respectively.

15. The suspension of claim 14, wherein one or more of the first or second ends of the wire portion deviates from parallel with the first or second axis.

16. A method of assembling an isolator system for a vehicle seat, the method comprising:
providing a Z-shaped link having an internal wire portion and an overmolded plastic exterior portion;
engaging a first leg of the Z-shaped link with an isolator frame along a first axis defined by the first leg, so that the first leg is rotatable about the first axis relative to the isolator frame; and
engaging a second leg of the Z-shaped link with a portion of a vehicle along a second axis defined by the second leg, so that the second leg is rotatable about the second axis relative to the vehicle;
wherein engaging the first and second legs of the Z-shaped link with the isolator frame and the vehicle offsets rotational engagement of the isolator frame by the Z-shaped link from rotational engagement of the vehicle by the Z-shaped link, via a stem of the Z-shaped link, the stem extending between the first leg and the second leg of the Z-shaped link, transverse to the first and second axes.

17. The method of claim 16, wherein engaging the second leg of the Z-shaped link with the portion of the vehicle includes:
engaging the second leg of the Z-shaped link with a suspension frame of the vehicle seat along the second axis defined by the second leg, so that the second leg is rotatable about the second axis relative to the suspension frame.

18. The method of claim 17, further comprising:
limiting lateral deflection of the isolator frame relative to the suspension frame via contact between the overmolded portion of the Z-shaped link and a protrusion that extends away from one or more of the isolator frame or the suspension frame and towards the Z-shaped link.

19. The method of claim 16, further comprising:
rotatably securing the first leg of the Z-shaped link to the isolator frame via a first rivet; and
rotatably securing the second leg of the Z-shaped link to the vehicle via a second rivet.

20. The method of claim 16, further comprising:
restricting movement of the isolator frame in a first direction via contact between a tie bar arranged between opposing sides of the isolator frame and an edge of a cutout defined by the vehicle, the tie bar extending through the cutout defined by the vehicle.
